(19) United States
(12) Patent Application Publication
(10) Pub. No.: US 2026/0259097 A1
(43) Pub. Date: Sep. 3, 2026

(54) METHOD FOR SENSOR CALIBRATION AND METHOD FOR SENSOR OPERATION, AND PRESSURE SENSOR

(71) Applicant: Robert Bosch GmbH, Stuttgart (DE)

(72) Inventors: Paul Fehling, Tuebingen (DE); Sujaya Jayadevaiah Umesh, Reutlingen (DE)

(21) Appl. No.: 19/543,922

(22) Filed: Feb. 19, 2026

(30) Foreign Application Priority Data
Mar. 3, 2025 (DE) 10 2025 107 887.4

(51) Int. Cl. G01L 27/00; G01L 9/00

(52) U.S. Cl. CPC G01L 27/002; G01L 9/0072; G01L 9/008

(57) ABSTRACT

A method for sensor calibration of a pressure sensor for measuring a fluid pressure. The method includes: providing the pressure sensor, which comprises at least one sensor element that provides a sensor signal depending on the fluid pressure and has a transverse sensitivity to an acceleration; providing an acceleration actuator that can apply acceleration to the pressure sensor; providing an accelerometer that measures the acceleration and provides an acceleration signal depending on the acceleration; and during operation of the pressure sensor, performing a calibration process including applying acceleration generated by the acceleration actuator to the pressure sensor, and thereby both detecting at least one acceleration quantity of the acceleration signal and detecting at least one measured quantity of the sensor signal, and subsequently calculating a calibration value depending on the acceleration quantity and the measured quantity.

### CROSS REFERENCE

The present application claims the benefit under 35 U.S.C. § 119 of German Patent Application No. DE 10 2025 107 887.4 filed on March 3, 2025, which is expressly incorporated herein by reference in its entirety.

### FIELD

The present disclosure relates to a method for the sensor calibration of a pressure sensor. Furthermore, the present disclosure relates to a method for sensor operation and a pressure sensor.

### BACKGROUND INFORMATION

Germany Patent Application No. DE 10 2004 033 956 A1 describes a method for the functional testing of a pressure sensor with a membrane, which allows the deformation behavior of the membrane, i.e., the mechanical properties of the membrane essential for signal acquisition, to be checked in a self-test. This generates a defined force acting on the membrane, which corresponds to a defined target signal from the functioning pressure sensor. The actual signal from the pressure sensor, caused by the defined force, is then evaluated, wherein the actual signal is compared with the target signal. In this way, deviations in the deformation behavior of the membrane can be detected.

### SUMMARY

According to the present disclosure, a method for sensor calibration for measuring a fluid pressure is provided. According to an example embodiment, the method includes: providing the pressure sensor which includes at least one sensor element which provides a sensor signal depending on the fluid pressure and has a transverse sensitivity to an acceleration; providing an acceleration actuator which can apply acceleration to the pressure sensor; providing an accelerometer that measures the acceleration and provides an acceleration signal depending on the acceleration; during operation of the pressure sensor. performing a calibration procedure with the steps including applying acceleration generated by the acceleration actuator to the pressure sensor, and thereby both detecting at least one acceleration quantity of the acceleration signal as well as detecting at least one measured quantity of the sensor signal, and subsequently calculating a calibration value depending on the acceleration quantity and the measured quantity.

This allows the pressure sensor to be adaptively calibrated. The pressure sensor can perform a more accurate and reliable measurement. Changes in the sensor properties of the pressure sensor over time can be taken into account and compensated. The pressure sensor can be calibrated during operation as needed.

The pressure sensor can be a microelectromechanical pressure sensor. The pressure sensor can be used in a mobile device, for example a vehicle, a robot, a mobile terminal, in particular a smartphone.

The pressure sensor can measure surrounding fluid pressure, in particular ambient pressure. Fluid pressure can be gas pressure, in particular atmospheric pressure. The pressure sensor can be an absolute pressure sensor or a differential pressure sensor.

The pressure sensor can be designed as a media-robust pressure sensor. The pressure sensor can have a protective material, at least on the sensor element. The protective material can be viscoelastic. The protective material can be a gel or oil. The protective material can protect the sensor element from environmental influences from the sensor environment of the pressure sensor. The protective material can electrically isolate the sensor element from the sensor environment.

The transverse sensitivity of the sensor element to acceleration can be increased by the mass of the protective material present on the sensor element. The acceleration can be gravitational acceleration, centrifugal acceleration and/or transient acceleration.

The acceleration generated by the acceleration actuator can be an acoustic and/or mechanical vibration. The generated acceleration can be static or transient. With regard to the sensor element, the generated acceleration can act mainly in the normal direction towards the sensor element.

The sensor element can have a membrane that can be deflected depending on the fluid pressure, in particular in the normal direction. The pressure sensor can detect the deflection of the membrane capacitively and/or piezoresistively. The transverse sensitivity of the sensor element can arise from a deflection of the membrane due to acceleration.

The sensor signal can be an electrical signal. The sensor signal can be an analog or digital signal. The sensor signal can be provided by the pressure sensor as an analog signal and converted into a digital signal by signal processing, in particular an ASIC.

The acceleration actuator can be a piezoelectric actuator or an electromagnetic actuator. The acceleration actuator can be a loudspeaker. The acceleration actuator can cause acceleration acoustically and/or mechanically, in particular as a vibration. The acceleration actuator can be arranged adjacent to the pressure sensor. The acceleration actuator can actively, controllably and/or selectively initiate acceleration to the pressure sensor. The acceleration actuator can initiate acceleration to the pressure sensor only upon request, in particular only during the calibration process.

The calibration process can be performed while the pressure sensor is operating to measure fluid pressure. The operation of the pressure sensor can be a measuring operation for measuring the fluid pressure.

The calibration process can increase the accuracy of the pressure measurement of the pressure sensor. The calibration process can reduce deviations between the fluid pressure measured via the sensor signal and the actual fluid pressure.

According to an example embodiment, the detection of the acceleration quantity can be a measurement by the accelerometer. The detected acceleration quantity can allow verification of the generated acceleration. For example, the acceleration quantity can be used to detect the presence of the generated acceleration and/or a property of the generated acceleration. The acceleration quantity can specify an amplitude, a frequency, a gradient and/or a second derivative of the acceleration signal. The acceleration quantity can be at least one characteristic value calculated from the acceleration signal, for example an amplitude.

The detection of the measured quantity can be a measurement by the pressure sensor. The measured quantity can specify an amplitude, a frequency, a gradient and/or a second derivative of the sensor signal. The measured quantity can be at least one characteristic value calculated from the sensor signal, for example an amplitude.

The pressure sensor can have a housing in which the sensor element is arranged. The pressure sensor can be assigned to a sensor module. The sensor module can have a housing. The acceleration actuator and/or the accelerometer can be arranged in the sensor module.

According to an example embodiment, a processing unit can perform the calculation of the calibration value. The processing unit can be arranged inside or outside the sensor module.

The calibration value can be an offset value. The offset value can specify an offset of the sensor signal relative to an acceleration, in particular gravitational acceleration. The offset value can be calculated from the calibration value and the acceleration signal, for example by multiplication.

In a preferred embodiment of the present disclosure, it is advantageous if a previously known relationship between acceleration quantities and measured quantities is retrievably stored. The relationship can be stored in a storage unit. The storage unit can be arranged inside or outside the sensor module. The relationship can be an analytical or numerical relationship. The relationship can be represented as a lookup table. The relationship can assign assignment values on the one hand and acceleration quantities and measured quantities on the other hand to each other. The assignment values can correspond to the calibration values. The calibration values can be calculated from the assignment values. For example, the calibration values can be calculated by interpolating the assignment values.

In a preferred embodiment of the present disclosure, it is provided that the calibration value is calculated depending on the relationship based on the acceleration quantity and the measured quantity. The calibration value can correspond to the assignment value or be calculated from the assignment value that is assigned to the acceleration quantity and the measured quantity. The assignment value can be ascertained using the known acceleration quantity and the known measured quantity through the relationship.

In a specific embodiment of the present disclosure, it is advantageous if the calibration value is stored and applied to the sensor signal during further operation of the pressure sensor. The calibration value can be stored in a further memory unit. The further storage unit can be arranged inside or outside the sensor module. The sensor signal can be compared with the calibration value. The effects of acceleration on the sensor signal can be compensated by the calibration value. Through compensation, a compensated sensor signal can be calculated during the operation of the pressure sensor.

The compensation can be an offset compensation of the sensor signal with the offset value. The compensation can be performed depending on the acceleration signal of the accelerometer which detects the acceleration acting on the pressure sensor. For example, in a simple embodiment of the compensation, the calibration value can be multiplied by the acceleration signal and this effect can be subtracted from the sensor signal.

In a specific embodiment of the present disclosure, it is advantageous if a previously stored calibration value is replaced by the calibration value. This allows the calibration value to be adjusted dynamically. A change in the sensor properties of the pressure sensor from the operation of the pressure sensor can thereby be taken into account.

The previously stored calibration value can be deleted or archived and saved for possible evaluation, for example over the lifespan of the pressure sensor, in particular to detect long-term degradation processes.

A preferred configuration of the present disclosure is advantageous in which the calibration process is started depending on a trigger signal. The trigger signal can be output by an activation unit. The activation unit can be arranged inside or outside the sensor module. The trigger signal can be triggered regularly, manually and/or depending on at least one event. The event can be reaching a specific measured value and/or exceeding a predetermined limit value of the measured value of the pressure sensor, the accelerometer or a further sensor.

In a preferred embodiment of the present disclosure, it is advantageous if the method for sensor calibration can be carried out at predetermined time intervals. The trigger signal can be activated at the predetermined time intervals. The time intervals can be, for example, days or weeks.

According to the present disclosure, a method for sensor operation is also provided. The compensated sensor signal can be calculated, for example, by subtracting the calibration value from the sensor signal.

According to an example embodiment, the method for sensor operation can further comprise providing an accelerometer that measures an acceleration acting on the pressure sensor and provides an acceleration signal depending on the acceleration.

The method for sensor operation can further comprise measuring at least one acceleration signal of an acceleration acting on the pressure sensor by the accelerometer.

The calculation of the compensated sensor signal can be performed depending on the sensor signal, the acceleration signal and the calibration value. The compensated sensor signal can be calculated, for example, by subtracting the acceleration signal multiplied by the calibration value or a characteristic value calculated from the acceleration signal, such as an average value, from the sensor signal.

In an advantageous embodiment of the present disclosure, it is provided that an offset value is calculated depending on the calibration value, and the compensated sensor signal is calculated as a sensor signal corrected by the offset value. The compensated sensor signal can be corrected by subtracting the offset value from the sensor signal. The offset value can be calculated depending on the calibration value and the acceleration signal, for example by multiplying the calibration value and the acceleration signal or a characteristic value calculated from the acceleration signal.

According to the present disclosure, a pressure sensor is also provided. The pressure sensor can be designed as described above.

Further advantages and advantageous embodiments of the present disclosure can be found in the description of the figures and in the figures.

### BRIEF DESCRIPTION OF THE DRAWINGS

Example embodiments of the present disclosure are described in detail below with reference to the figures.

FIG. 1 shows a method for sensor calibration in a specific embodiment of the present disclosure.

FIG. 2 shows a method for sensor operation in a specific embodiment of the present disclosure.

FIG. 3 shows an overview of the allocation of various components involved in the methods.

### DETAILED DESCRIPTION OF EXAMPLE EMBODIMENTS

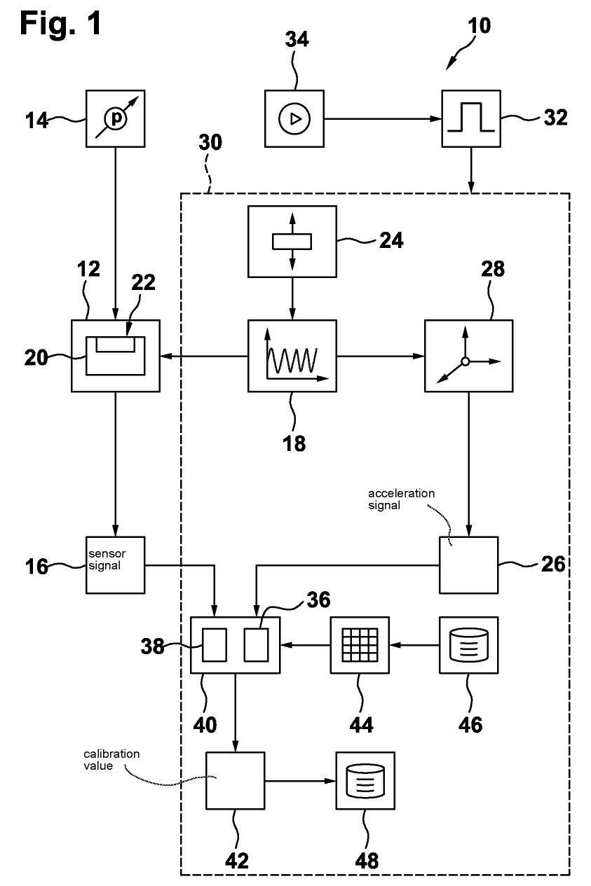

FIG. 1 shows a method for sensor calibration in a specific embodiment of the present disclosure. The method for sensor calibration 10 of a pressure sensor 12 for measuring a fluid pressure 14 comprises providing the pressure sensor 12, which comprises at least one sensor element 20 which provides a sensor signal 16 depending on the fluid pressure 14 and has a transverse sensitivity to an acceleration 18. The sensor element 20 comprises a membrane 22 which can be deflected by the fluid pressure 14 and which has a transverse sensitivity to the acceleration 18. The sensor element 20 provides the sensor signal 16 depending on the deflection of the membrane 22, for example by means of a capacitive or piezoresistive measuring principle, to detect the deflection.

Furthermore, an acceleration actuator 24 is provided which can apply acceleration 18 to the pressure sensor 12. The acceleration actuator 24 is, for example, a piezoelectric or electromagnetic actuator, such as a loudspeaker. In this case, the acceleration actuator 24 causes a transient, in particular periodic, acceleration 18 at the pressure sensor 12. For this purpose, the acceleration actuator can at least be arranged in the vicinity of the pressure sensor 12.

Furthermore, an accelerometer 28 is provided which measures the acceleration 18 and provides an acceleration signal 26 depending on the acceleration 18.

During operation of the pressure sensor 12 for measuring the fluid pressure 14, a calibration process 30 takes place, which is started in particular depending on a trigger signal 32. The trigger signal 32 can be output by an activation unit 34, for example at predetermined time intervals or manually as well depending on a user requirement.

The calibration process 30 comprises applying an acceleration 18 generated by the acceleration actuator 24 to the pressure sensor 12, in particular a transient, for example periodic, acceleration, and thereby both detecting at least one acceleration quantity 36 of the acceleration signal 26 as well as detecting at least one measured quantity 38 of the sensor signal 16. The measured quantity 38 and the acceleration quantity 36 can be detected by a processing unit 40, in particular by signal processing. The processing unit 40 can be a digital signal processor (DSP).

Subsequently, a calibration value 42 is preferably calculated by the processing unit 40 depending on the acceleration quantity 36 and the measured quantity 38. The calibration value 42 can be an offset value with respect to the transverse sensitivity of the sensor signal to the acceleration 18, with which the sensor signal 16 can be compensated.

In particular, a previously known relationship 44 between acceleration quantities 36 and measured quantities 38 is retrievably stored in a storage unit 46. The relationship 44 can assign assignment values on the one hand and acceleration quantities 36 and measured quantities 38 on the other hand to each other. The calibration value 42 can correspond to the assignment value identified via the detected measured quantity 38 and the detected acceleration quantity 36 with the relationship 44 or be calculated depending thereon, for example by interpolation.

The calibration value 42, for example, is stored in a further storage unit 48 and used to compensate for the sensor signal 16 during further operation of the pressure sensor 12. A previously stored calibration value can be replaced by the calibration value 42.

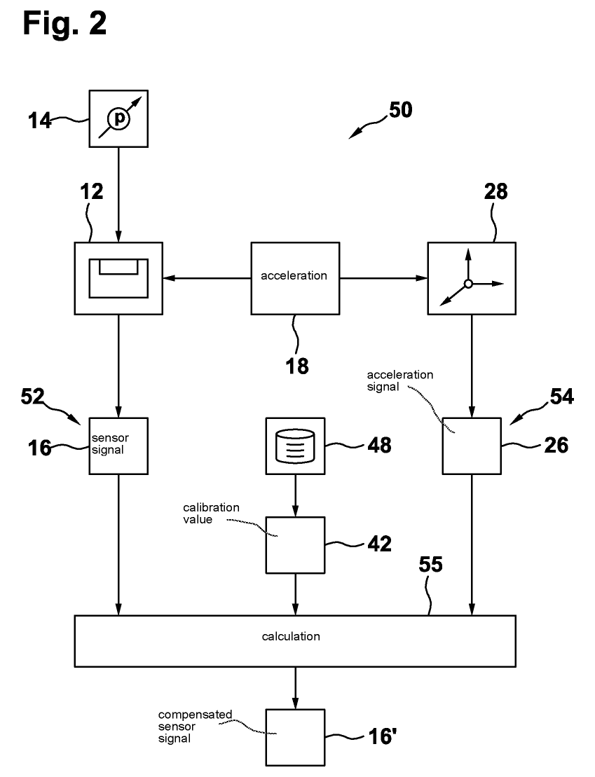

FIG. 2 shows a method for sensor operation in a specific embodiment of the present disclosure. The method for sensor operation 50 comprises, in addition to providing the pressure sensor 12 as described in FIG. 1, a measurement 52 of at least one sensor signal 16 at the fluid pressure 14 applied to the pressure sensor 12, a measurement 54 of at least one acceleration signal 26 of an acceleration 18 acting on the pressure sensor 12, for example a gravitational acceleration, by the accelerometer 28 and a retrieval of the calibration value 42 calculated by the method for sensor calibration described in FIG. 1 from the further storage unit 48.

Subsequently, a calculation 55 of a compensated sensor signal 16‘ is performed depending on the sensor signal 16, the acceleration signal 26 and the calibration value 42. The offset value can be calculated from the calibration value 42 and the acceleration signal 26, for example by multiplying the calibration value 42 and the acceleration signal 26. The sensor signal 16 can, for example, be calculated and output as a compensated sensor signal 16‘ by subtracting the offset value from the sensor signal 16.

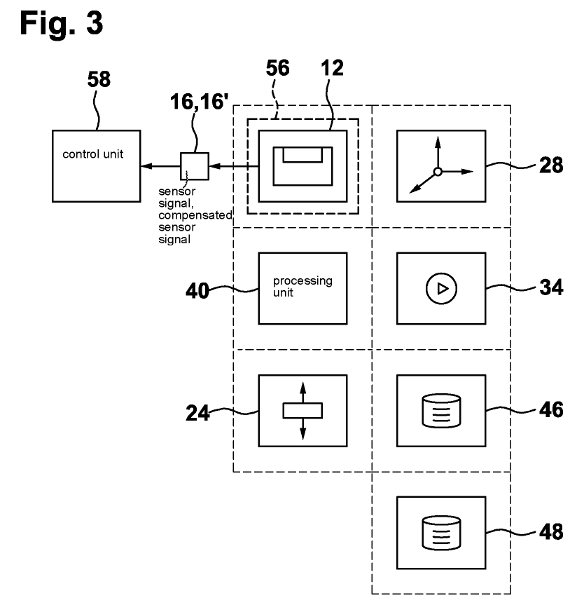

FIG. 3 shows an overview of the allocation of various components involved in the methods. The components here are the pressure sensor 12, the acceleration actuator 24, the accelerometer 28, the processing unit 40, the activation unit 34, the storage unit 46 and the additional storage unit 48. The depicted sequence or relative position of the components is for illustrative purposes only and can differ from the actual relative position and distance of the components to each other implemented in the application. The assignment overview is for clearly indicating how the components can be assigned to each other.

Assuming that the pressure sensor 12 is arranged in a sensor module 56. Then the pressure sensor 12 can be arranged alone in the sensor module 56, while all other components are arranged outside of the sensor module 56. At least one or more of the or all of the other components, for example the accelerometer 28, can also be arranged in the sensor module 56.

The pressure sensor 12 can output the sensor signal 16 or the compensated sensor signal 16‘ to a control unit 58, which further processes the sensor signal 16 or the compensated sensor signal 16‘. Apart from the sensor module 56 with the pressure sensor 12, the accelerometer 28 and the acceleration actuator 24, at least one or more or all of the remaining components of the control unit 58 can be assigned.

What is claimed is:

1. A method for sensor calibration of a pressure sensor for measuring a fluid pressure, comprising the following steps:
providing the pressure sensor which includes at least one sensor element which provides a sensor signal depending on the fluid pressure and has a transverse sensitivity to an acceleration;
providing an acceleration actuator which can apply acceleration to the pressure sensor;
providing an accelerometer that measures the acceleration and provides an acceleration signal depending on the acceleration;
during operation of the pressure sensor, performing a calibration procedure including:
applying acceleration generated by the acceleration actuator to the pressure sensor, and thereby both detecting an acceleration quantity of the acceleration signal and detecting a measured quantity of the sensor signal, and
subsequently calculating a calibration value depending on the acceleration quantity and the measured quantity.

2. The method for sensor calibration according to claim 1, wherein a previously known relationship between acceleration quantities and measured quantities is retrievably stored.

3. The method for sensor calibration according to claim 2, wherein the calibration value is calculated depending on the previously known relationship based on the acceleration quantity and the measured quantity.

4. The method for sensor calibration according to claim 1, wherein the calibration value is stored and applied to the sensor signal during further operation of the pressure sensor.

5. The method for sensor calibration according to claim 4, wherein a previously stored calibration value is replaced by the calibration value.

6. The method for sensor calibration according to claim 1, wherein the calibration procedure is started depending on a trigger signal.

7. The method for sensor calibration according to claim 1, wherein the calibration procedure is carried out at predetermined time intervals.

8. A method for sensor operation of a pressure sensor for measuring a fluid pressure, comprising the following steps:
providing the pressure sensor which includes at least one sensor element which provides a sensor signal depending on the fluid pressure and has a transverse sensitivity to an acceleration;
measuring a sensor signal when fluid pressure is applied to the pressure sensor;
retrieving the calibration value calculated by a method for sensor calibration; and
calculating a compensated sensor signal at least depending on the sensor signal and the calibration value;
wherein the method for sensor calibration includes:
providing an acceleration actuator which can apply acceleration to the pressure sensor,
providing an accelerometer that measures the acceleration and provides an acceleration signal depending on the acceleration,
during operation of the pressure sensor, performing a calibration procedure including:
applying acceleration generated by the acceleration actuator to the pressure sensor, and thereby both detecting an acceleration quantity of the acceleration signal and detecting a measured quantity of the sensor signal, and
subsequently calculating a calibration value depending on the acceleration quantity and the measured quantity.

9. The method for sensor operation according to claim 8, wherein an offset value is calculated depending on the calibration value, and the compensated sensor signal is calculated as the sensor signal corrected by the offset value.

10. A pressure sensor for detecting a fluid pressure and configured to be calibrated during operation by a method for sensor calibration, the method comprising the following steps:
providing the pressure sensor which includes at least one sensor element which provides a sensor signal depending on the fluid pressure and has a transverse sensitivity to an acceleration;
providing an acceleration actuator which can apply acceleration to the pressure sensor;
providing an accelerometer that measures the acceleration and provides an acceleration signal depending on the acceleration;
during operation of the pressure sensor, performing a calibration procedure including:
applying acceleration generated by the acceleration actuator to the pressure sensor, and thereby both detecting an acceleration quantity of the acceleration signal and detecting a measured quantity of the sensor signal, and
subsequently calculating a calibration value depending on the acceleration quantity and the measured quantity.
